(19) United States
(12) Patent Application Publication
(10) Pub. No.: US 2026/0219483 A1
(43) Pub. Date: Jul. 30, 2026

(54) Light reflector element and atomic device

(71) Applicant: DEUTSCHES ZENTRUM FÜR LUFT-UND RAUMFAHRT E.V., Bonn-Oberkassel (DE)

(72) Inventors: Christian SCHUBERT, Hannover (DE); Waldemar HERR, Hannover (DE); Vanessa Annabell GRAUER, Eschwege (DE)

(21) Appl. No.: 19/407,683

(22) Filed: Dec. 3, 2025

(30) Foreign Application Priority Data
Dec. 10, 2024 (DE) 10 2024 136 843.8

(51) Int. Cl. G02B 17/00; G21K 1/30

(52) U.S. Cl. CPC G02B 17/002; G21K 1/30

(57) ABSTRACT

A light reflector element has multiple reflector surfaces aligned at various predefined angles with respect to a predefined light irradiation direction. The reflector surfaces are arranged annularly around a center, wherein respective pairs of reflector surfaces are arranged diametrically opposite to one another so that light irradiated in the light irradiation direction is deflected by the reflector surfaces in light beams which extend in different spatial directions toward one another and meet in a center axis, which extends in the light irradiation direction through the center. The light reflector element has one or more pairs of the reflector surfaces associated with one another, in which one reflector surface of the pair is aligned at an angle in the range of 46° to 89° with respect to the predefined light irradiation direction of the light reflector element and the other reflector surface of the same pair is aligned at an angle in the range of 1° to 44° with respect to the predefined light irradiation direction of the light reflector element.

### FIELD OF THE INVENTION

The invention relates to a light reflector element which has multiple reflector surfaces aligned at various predefined angles with respect to a predefined light irradiation direction of the light reflector element, wherein the reflector surfaces are arranged, for example annularly, around a center of the light reflector element, wherein respective pairs of reflector surfaces associated with one another are arranged diametrically opposite to one another with respect to the center of the light reflector element, so that light incident in the light irradiation direction is deflected by the reflector surfaces in light beams which extend in different spatial directions toward one another and meet in a center axis which extends in the light irradiation direction through the center. The center axis is therefore aligned parallel to the light irradiation direction. The light beams deflected by the reflector surfaces of multiple or all reflector surfaces can meet at the same point of the center axis, which then forms an interaction zone for cooling trapped atoms.

The invention additionally relates to an atomic device, such as an atomic interferometer or a quantum gradiometer, having at least one such light reflector element. In general, the invention relates to the field of arbitrary atomic devices having an atom trap and laser-cooled atoms in the atom trap, in particular having a magnetooptical trap (MOT). In particular, the invention relates to atomic-interferometer gravimeters and gradiometers formed thereby.

### BACKGROUND

Atomic-interferometry gravimeters offer absolute gravity measurements having long-term stability. In comparison to the widespread laser gravimeters (FG5X), their measurement principle offers the possibility of quasi-continuous data recording over a longer period of time and the perspective of a higher accuracy. Transportable and commercial devices based on atomic-interferometry measurements have already been implemented and also operated on a mobile platform such as a ship. An essential component of an atomic-interferometry gravimeter is the source for cold atoms. These are typically based on laser cooling in magnetooptical traps and polarization gradient cooling. A three-dimensional magnetooptical trap also requires, in addition to magnetic fields, light fields which are each typically irradiated antiparallel or nearly antiparallel on the three spatial axes in order to form a so-called interaction zone for cooling trapped atoms. This implies a comparatively complex structure having multiple beamforming optical units and corresponding optical accesses to the vacuum system in which the atoms are trapped and cooled. Specially designed pyramid or grid structures have been successfully used for the purpose of creating a beam geometry which can cool effectively in all three spatial axes from a single incident laser beam.

Another important application of atomic interferometers is their use for gradiometers, in which two spatially separated gravimeters are operated simultaneously. The first derivative of the gravity, the gravitation gradient, can be derived from the differential signal. A common-noise rejection results for the differential signal, in which the gradiometer signal is only worsened by technical noise sources which act differently on the two gravimeters. It is of particular importance here that the two gravimeters are operated as symmetrically as possible in order to profit maximally from the described noise rejection.

The prior art in gradiometry using compact atomic interferometers is described well in the publication WO 2014/106811 A2. The gradiometer therein consists of two (or three) interaction zones, in each of which laser light is directed from all six spatial directions onto an atomic ensemble. A single laser beam is used for this purpose, which is directed by each of two (or three) light reflector elements onto the interaction zones. The two light reflector elements are arranged so that the second light reflector element is located behind a central hole of the first light reflector element (or the third light reflector element has a central hole for the second light reflector element).

The technical challenge represented by acceleration measurements using cold atoms is the implementation of compact and durable devices in order to generate reliable measurement data and maintain high sensitivities in spite of demanding and dynamic environmental conditions. In particular for gradiometric measurements, these aspects are currently entering the foreground more and the requirements for the sensors in this case are high.

Current implementations for cooling and trapping atomic clouds for the later interferometry process include various pyramid mirrors or grating configurations of the three-dimensional magnetooptical trap (3D-MOT). These types of 3D-MOTs have contributed to structures for atomic interferometers being more compact, since thus only one laser beam is required or the number of required optical accesses and fibers is significantly reduced. The optical elements for this purpose are complex to produce, however, and can imply the necessity for further elements in the structure, which can result in undesired polarization effects or phase interference. One challenge in this case is the uniform intensity distribution of the laser light in all three spatial axes for the 3D-magnetooptical trap and molasses cooling. However, this is of great importance, since an uneven distribution of the light influences the performance capacity of the implemented laser cooling and can thus degrade the performance capacity of the sensor as a whole.

Current implementations of pyramid MOTs are usually constructed so that they eliminate four of the six spatial directions required for effective cooling by way of reflective surfaces. The remaining two directions are each covered by the incident and reflected laser light field.

The typical variants with reflection at a 90° angle require a Liquid Crystal Variable Retarder (LCVR) in the retroreflection path for switching between MOT phase and interferometry phase or detection phase during the interferometry cycle when an energy transition favorable for the detection is to be driven in the atom (for example, a so-called closed transition).

A further disadvantage is that the center of the pyramid element has to be illuminated, which can potentially interfere with the operation of interleaved interferometers or other measurement methods using laser-cooled atoms.

### SUMMARY

The invention is therefore based on the object of specifying an improved light reflector element and an atomic device formed thereby.

This object is achieved by a light reflector element of the type mentioned at the outset, wherein the light reflector element has one or more pairs of the reflector surfaces associated with one another, in which one reflector surface of the pair is aligned at an angle in the range of 46° to 89° with respect to the predefined light irradiation direction of the light reflector element and the other reflector surface of the same pair is aligned at an angle in the range of 1° to 44° with respect to the predefined light irradiation direction of the light reflector element. The special feature in at least one pair of these reflector surfaces is therefore that a part of the incident light field is effectively deflected at a steep angle in relation to the light irradiation direction by the one reflector surface and another part of the incident light field is effectively deflected at a flat angle in relation to the light irradiation direction by the other reflector surface so that as a whole the vectorial contributions of the light field components can cover all spatial axes, which enables, for example, the implementation of a three-dimensional atom trap.

The light irradiated in the light irradiation direction is therefore not deflected orthogonally to the light irradiation direction by the reflector surfaces, but rather at an oblique angle thereto. This can be implemented, for example, as a pyramid optical unit. Due to the optimized deflection direction of the reflector surfaces, incident light beams are deflected at an angle in relation to the surface normal so that as a whole the vectorial contributions of the light fields still cover all spatial axes, i.e. have components in all spatial axes, without the light that passes the light reflector element in the center having to be reflected into itself for the operation as a magnetooptical trap, i.e. it does not have to be reflected back by a mirror arranged in the light irradiation direction behind the light reflector element. This has the advantage that a controllable polarization element such as an LCVR is not required for switching between the MOT phase and the interferometry phase or the detection phase during the interferometry cycle in the retroreflection path, since such a retroreflection path as such is no longer required for the magnetooptical trap. Phase errors in the atomic interferometer due to wavefront interference can likewise be reduced due to the elimination of the controllable polarization element. Moreover, it is possible that coils for the magnetooptical trap can be arranged at or in the vacuum chamber instead of around the vacuum chamber.

A further advantage is that the center of the light reflector element does not have to be illuminated, due to which interleaved interferometers or other measurement methods using laser-cooled atoms are interfered with less.

The possible applications of the light reflector element are not restricted to atomic interferometers. It is advantageous for an access in the light beam direction behind the light reflector element to remain free, at which no mirror is required for retroreflection in the light irradiation direction. This access can be used, for example, for an optical dipole trap, detection optical units, an atomic oven, and the like in another atomic-optical setup.

According to one advantageous embodiment of the invention, it is provided that the light reflector element has one or more pairs of the reflector surfaces associated with one another, in which one reflector surface of the pair is aligned at an angle of at least approximately 67.5°, i.e. in consideration of error tolerances, with respect to the predefined light irradiation direction of the light reflector element and the other reflector surface of the same pair is aligned at an angle of at least approximately 22.5° with respect to the predefined light irradiation direction of the light reflector element. In this way, the effectiveness of a light reflector element as an atom trap can be made particularly efficient. Three-dimensional holding and cooling of the trapped atoms by the laser light can be implemented without retroreflection path by multiple pairs of such reflector surfaces associated with one another, which are each arranged offset by a certain circumferential angle in the circumferential direction. The light beams deflected by the reflector surfaces then strike the center axis at a 45° angle.

According to one advantageous embodiment of the invention, it is provided that in one or more pairs of the reflector surfaces associated with one another, one reflector surface of the pair is aligned at an angle W1 with respect to the predefined light irradiation direction of the light reflector element and the other reflector surface of the same pair is aligned at an angle W2 with respect to the predefined light irradiation direction of the light reflector element, wherein the sum of W1 and W2 is equal or nearly equal to 90°. It is possible in this way for light beams to be obliquely deflected with the same light irradiation direction by a pair of the reflector surfaces associated with one another and to run aligned with one another, so that they meet at the center axis.

According to one advantageous embodiment of the invention, it is provided that the number of pairs of the reflector surfaces of the light reflector element associated with one another is equal to 3 or is a multiple of 3. This enables a simple structure of the light reflector element and accordingly simple and favorable production. A pair of the reflector surfaces associated with one another can be arranged offset by a specific circumferential angle in the circumferential direction to an adjacent pair in each case here.

According to one advantageous embodiment of the invention, it is provided that the light reflector element has at least one further pair of the reflector surfaces associated with one another, in which both reflector surfaces of the pair are aligned at an angle of 45° with respect to a straight line which extends orthogonally to the predefined light irradiation direction of the light reflector element and intersects the center axis. Accordingly, the light reflector element has, in addition to the above-mentioned pairs of reflector surfaces of which one is configured at an angle in the range of 46° to 89° and the other reflector surface is aligned at an angle in the range of 1° to 44°, the mentioned at least one further pair of the reflector surfaces associated with one another, which do not have this oblique-angled arrangement. Using the further reflector surfaces, for example, light beams pointing toward one another can be generated from the light beams incident in the light irradiation direction, which are directed in the orthogonal direction onto the center axis.

In a first variant, the reflector surfaces of the further pair can be aligned at an angle of or nearly of 45° in relation to the light irradiation direction. This permits a direct reflection of the light incident in the light irradiation direction orthogonal to the center axis.

According to one advantageous embodiment of the invention, it is provided that the light reflector element has, for each reflector surface of the further pair of the reflector surfaces associated with one another, at least one auxiliary reflector surface associated with this reflector surface, which deflects light irradiated in the predefined light irradiation direction of the light reflector element onto the associated reflector surface. An arrangement of reflector surfaces pivoted in relation to one another is created by a reflector surface of the further pair and an auxiliary reflector surface associated with this reflector surface, by which a particularly effective generation of light radiation in the orthogonal direction to the center axis can be generated. For example, the reflector surface of the further pair can be aligned parallel to the light irradiation direction. The auxiliary reflector surface can then be aligned at an angle of 45° with respect to the predefined light irradiation direction of the light reflector element. The light irradiated in the light irradiation direction can be deflected by the auxiliary reflector surface onto the associated reflector surface of the further pair and then deflected orthogonally by this reflector surface in the direction of the center axis.

The reflector surfaces can be arranged at uniform angular intervals to one another in the circumferential direction around the center axis. The reflector surfaces of a pair of reflector surfaces can be diametrically opposite with respect to the center of the light reflector element.

According to one advantageous design of the invention, it is provided that a light-transmitting section is arranged in each case between reflector surfaces adjacent in the circumferential direction, through which the light incident in the light irradiation direction can radiate through the light reflector element. In the light reflector element according to the invention, not only a central inner area of the light reflector element is therefore made light-transmitting, as in the prior art, rather alternatively or additionally sections are created between the reflector surfaces in the circumferential direction, which are light-transmitting. Advantages can be achieved by such a design of the light reflector element:
smaller area to be covered for the laser beam with light reflector elements arranged one behind another
symmetrical intensity distribution in the interaction zones
improved symmetries in the number of the atoms in the two interaction zones
corresponding improvement of the gradiometer signal due to systematic effects
reduction in size of the apparatus with advantages for the compactness
lower required laser power and therefore reduced restrictions for the compact structure and the power consumption

The invention enables an improved design of the light reflector elements, in which the allocation of the available laser light is not achieved by a radial or transmitting segmentation, but rather by an angle-dependent segmentation of the reflector surfaces. This enables asymmetry of the optical configuration. At the same time, the complexity of the light reflector elements is reduced, which do not necessarily have to be manufactured from light-transmissive material and can be designed identically for all two, three, or more interaction zones. The manufacturing is thus simplified. The symmetry due to the use of identical optical elements furthermore reduces differential errors which could otherwise influence the signal quality.

The reflector surfaces are configured to reflect light, in particular with a reflectance of essentially 100%. The reflector surfaces can be designed like mirrors, for example. The reflector surfaces can be designed as uniform, planar continuous reflector surfaces or as a large number of individual reflector surfaces which are arranged staggered adjacent to one another on the reflector element. One reflector surface can be delimited from an adjacent reflector surface in that it is arranged at a different angle to the adjacent reflector surface and/or with offset to the adjacent reflector surface. A reflector surface can be designed, for example, as a level mirrored surface.

According to one advantageous embodiment of the invention, it is provided that one, multiple, or all of the light-transmitting sections are designed as a free space in which no material is arranged. This has the advantage that the light reflector element can be designed and produced particularly easily. Alternatively, a filler material which is light-transmissive, such as a glass or plastic material, can also be arranged in one, multiple, or all light-transmitting sections.

According to one advantageous embodiment of the invention, it is provided that the reflector surfaces are arranged at a distance from the center so that a central light-transmitting section is formed around the center, through which the light incident in the light irradiation direction can radiate through the light reflector element. The light of the light source can be guided by the central light-transmitting section, for example, to a mirror arranged in the light irradiation direction behind the light reflector element or a further light reflector element arranged behind it, by which the light is reflected back for carrying out the interferometry.

The light reflector element can be assembled in multiple parts from various individual parts. For example, the individual reflector surfaces can be applied as mirrored components to a base component, which is used as the carrier for the reflector surfaces. According to one advantageous design of the invention, it is provided that the light reflector element is designed as a monolithic component. This enables a very simple and cost-effective production of a light reflector element, which is moreover very mechanically stable. This additionally simplifies the integration of the light reflector element into an atomic interferometer, the adjustment is simplified.

The object mentioned at the outset is additionally achieved by a reflector arrangement which includes at least one first light reflector element and at least one second light reflector element, wherein the second light reflector element is arranged behind the first light reflector element in the light irradiation direction. The first light reflector element is designed here as a light reflector element of the above-described type, i.e. as a light reflector element according to the invention. The second light reflector element can also be designed as a light reflector element according to the invention, but it can also be designed differently. Light radiating through the light-transmitting sections of the first light reflector element can be incident here on the reflector surfaces of the second light reflector element. Two interaction zones of a quantum gradiometer can advantageously be formed by such a reflector arrangement. The required surface to be covered for the laser beam is relatively small here. Moreover, a symmetrical intensity distribution can be implemented in the interaction zones in a simple manner.

The first and the second light reflector element can advantageously be made equal in size with respect to the dimensions of their optically active reflector surfaces. Furthermore, it is advantageous if the second light reflector element is arranged behind the first light reflector element along the same center axis in the light irradiation direction, thus is arranged concentrically to the first light reflector element.

The object mentioned at the outset is additionally achieved by an atomic device, in particular an atomic interferometer, having at least one laser light source and an atom trap, which has at least one first interaction zone for cooling trapped atoms by way of laser light of the laser light source irradiated from opposite directions on the trapped atoms, wherein the atomic device has a first light reflector element of the above-explained type, wherein the light emission direction of the laser light source is aligned in the predefined light irradiation direction of the first light reflector element, wherein the first interaction zone is at least partially formed by the first light reflector element. The above-explained advantages can also be implemented in this way. The atomic device can be an arbitrary atomic device having atoms which are laser-cooled in the atom trap. The atom trap can be designed as a magnetooptical trap (MOT).

The atom trap can be designed as a three-dimensionally acting atom trap (for example, 3D-MOT), wherein the vectorial components of the laser light irradiated from opposite directions on the trapped atoms in the first interaction zone comprise all spatial axes. The structure of the atomic device can also be simplified in this way.

The magnetooptical trap functions here as an atom trap configured to trap an atom cloud. The magnetooptical trap includes a magnetic field device in order to implement a magnetically active part of the atom trap therewith. Furthermore, the atomic interferometer includes at least one controllable laser light source, for example a laser, by which light is emitted in the predefined light irradiation direction onto the light reflector element or elements or the reflector arrangement. The laser cooling of the trapped atoms in the interaction zone or zones is implemented in this way.

According to one advantageous embodiment of the invention, it is provided that the atom trap is designed on the side of the first light reflector element facing away from the laser light source without a light beam path extending along the center axis. Accordingly, the retroreflection light path can be avoided at least for the cooling of the atoms, by which the phase errors in the atomic interferometer can be minimized and the overall structure can be simplified, in particular a LCVR or similar component is not required for the control of the reflected light.

According to one advantageous embodiment of the invention, it is provided that the atomic device has at least two interaction zones for cooling trapped atoms by way of laser light irradiated onto the trapped atoms from opposite directions, wherein the atomic device has a second light reflector element, which is arranged behind the first light reflector element in the light irradiation direction, wherein a second interaction zone is at least partially formed by the second light reflector element. The atomic device can have, for example, a reflector arrangement of the above-described type. The second light reflector element can be designed as a light reflector element according to the invention, as described above, or as a differently designed light reflector element, for example a light reflector element according to the prior art. The atomic device can be designed, for example, as a quantum gradiometer.

The invention is suitable, for example, for applications in the field of navigation, for rotation and acceleration measurements, for example as part of an inertial quantum measuring unit for assisting or in place of conventional inertial measuring units, in particular in areas without a reliable global navigation system (GNSS).

In the meaning of the present invention, the indefinite term “a” is not to be understood as a numeral. Thus, for example, when reference is made to a component, this is to be interpreted in the meaning of “at least one component”. Insofar as angle specifications are made in degrees, this relates to a circle dimension of 360 degrees (360°).

### DESCRIPTION OF THE DRAWINGS

The invention will be explained in more detail hereinafter on the basis of exemplary embodiments using drawings.

In the figures

FIG. 1 shows an atomic device in a very schematic lateral sectional view,

FIG. 2 shows a light reflector element in a top view,

FIG. 3 shows the light reflector element from FIG. 2 in a lateral sectional view,

FIG. 4 shows a light reflector element of a further embodiment in a top view,

FIG. 5 shows the light reflector element from FIG. 4 in a lateral sectional view,

FIG. 6 shows a light reflector element of a further embodiment in a top view,

FIG. 7 shows the light reflector element from FIG. 6 in a lateral sectional view in a further plane of section,

FIG. 8 shows the light reflector element from FIG. 6 in a perspective view,

FIG. 9 shows the introduction of the laser light in the cooling configuration,

FIG. 10 shows the introduction of the laser light in the interferometry configuration.

### DETAILED DESCRIPTION

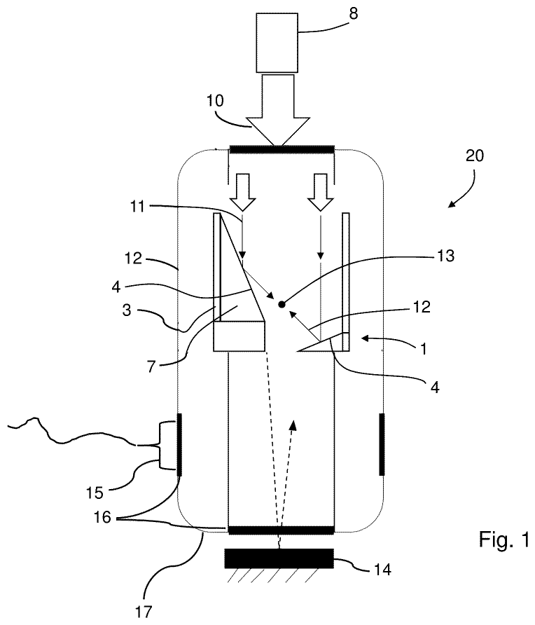

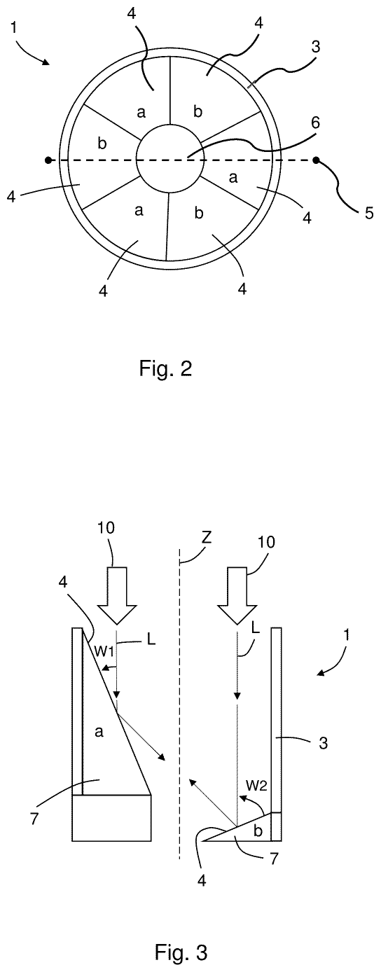

FIG. 1 shows an atomic device 20, for example an atomic interferometer. The atomic device 20 has a coherent light source 8, for example a laser, by which the light 10 is emitted in the light irradiation direction L. The atomic device 20 furthermore has a vacuum chamber 17, in which a light reflector element 1 of the above-described type is arranged, for example as shown in FIGS. 2, 3. It can be seen that the wave vector 11 of the incident light 10, which is aligned in the light irradiation direction L with respect to the light reflector element 1, is directed onto an interaction zone 13, in which atoms can be trapped in an atom trap and cooled by the laser light. In addition, the direction of the light of the light source 8 reflected on the reflector surfaces 4 is shown by wave vectors 12.

As can be seen, a pair of reflector surfaces 4 associated with one another have different angles with respect to the light irradiation direction L. The reflector surface 4 shown on the left has an angle of less than 45°, for example 22.5°, the right reflector surface 4 has an angle greater than 45°, for example 67.5°. A part of the incident light field 10 is deflected with a vectorial component in the same direction as the wave vector 11 and another part of the incident light field 10 is deflected with a vectorial component opposite to the wave vector 11 by this type of optics, wherein the opposing wave vectors 12 meet again in the interaction zone 13. The wave vectors 12 are therefore aligned antiparallel to one another. Overall, all spatial axes can be covered by the vectorial contributions of the light field components due to such optics.

In this way, vectorial light components occur in all six spatial directions in the interaction zone 13, so that a three-dimensionally acting atom trap can already be implemented using the one light reflector element 1, without a reflection by a mirror behind the light reflector element 1 being necessary for this purpose. In this way, three-dimensional laser cooling of the atoms is possible with low expenditure.

In this case, the design of the light reflector element 1 permits a uniform light pressure on the atoms in the interaction zone 13 in the direction of the light irradiation direction L and opposite to the light irradiation direction L.

For the subsequent performance of an interferometry cycle, the atoms trapped in the atom trap, i.e. the interaction zone 13, can then be decoupled and fall downward in the vacuum chamber 17, for example. The vacuum chamber 17 can contain optically transparent sight glasses or view ports, through which the evaluation of the interferometry outputs can then take place by means, for example, of a camera or a photodiode. Moreover, a mirror 14 for the interferometry can be present on the side of the vacuum chamber 17 facing away from the light source 8. A detection system 15 for the evaluation of the interferometry outputs can be placed, for example, in front of a view port 16.

The mirror 14 can also be mounted inside the vacuum chamber 17. Mounting the mirror 14 on a remote-controlled mirror holder is also conceivable, by which the reflected component of the light field can be tilted by automatic control so that the effect on the magnetooptical trap can be reduced. A further alternative for minimizing its effect on the magnetooptical trap is the arrangement, for example, of a shutter between the lower sight glass 16 and the mirror 14.

The described exemplary embodiment of the optics likewise enables a structure having two light reflector elements 1 arranged one behind another, which form a reflector arrangement. With such a reflector arrangement 9, for example, a quantum gradiometer can be implemented so that a measurement of the gravitation gradient can be implemented with a light source 8.

FIG. 2 shows the light reflector element 1 from FIG. 1 in a top view, FIG. 3 shows the light reflector element 1 in a sectional view in the central plane of section 5 shown in FIG. 2. The light reflector element 1 from FIGS. 2, 3 has a base body 3, on which multiple, in this case 6, reflector surfaces 4 arranged evenly distributed over a circumferential angle coordinate are arranged, which are arranged obliquely with respect to a predefined light irradiation direction L of the light reflector element 1. The reflector surfaces 4 are each formed as mirrored surfaces of a reflector body 7. The reflector surfaces 4 can each be arranged opposing in pairs, i.e. two opposing reflector surfaces 4 form a pair a, b of reflector surfaces 4, wherein other arrangements are also conceivable. The reflector surfaces 4 are each arranged opposite to one another symmetrically with respect to a center of the light reflector element 1, in particular with point symmetry or mirror symmetry. The center of the light reflector element 1 is illustrated in FIG. 2 by a center axis Z. The center axis Z extends through the center of the light reflector element 1 in the light irradiation direction L.

As can be seen, for example, three pairs a, b of reflector surfaces 4 can be present. The reflector surfaces 4 do not extend to the center of the light reflector element 1, but rather end before this, so that a central light-transmitting area 6 is present around the center axis Z. As FIG. 3 shows, the reflector surface a of the pair a, b of reflector surfaces 4 is aligned at an acute angle W1 in relation to the light irradiation direction L, the associated reflector surface b of the same pair a, b is aligned at an obtuse angle W2 in relation to the

light irradiation direction L. The sum of W1 and W2 is 90°. The interaction zone 13 can be irradiated uniformly with light from all six spatial directions by the three pairs a, b of reflector surfaces 4 arranged offset in the circumferential direction.

The light reflector element 1 can be produced, for example, from a raw component by cutting machining, for example by milling. It is also possible to produce the light reflector element from two parts, which are then placed one inside the other. Advantageous illumination options of the light reflector element 1 are a Gaussian beam centered on the center axis Z, a “flattop” or “top hat” beam profile, or an annular beam profile.

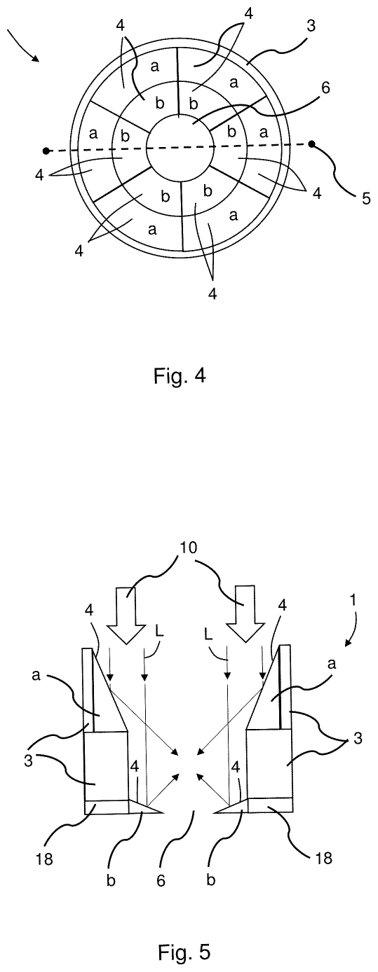

A further embodiment of a light reflector element 1 will be explained on the basis of FIGS. 4 and 5. FIG. 5 again shows a sectional view along the central plane of section 5 shown in FIG. 4. It can be seen that the light reflector element 1 has a total of 12 reflector surfaces 4, which are arranged in the form of two concentric ring arrangements around the center or the light-transmitting central section 6. The two annular arrangements of the reflector surfaces 4 are again divided into six sectors in the circumferential direction, as in the embodiment of FIGS. 2 and 3. In this case, a pair a, b of reflector surfaces 4 associated with one another are each formed by a reflector surface a aligned at the angle W1 in relation to the light irradiation direction L and arranged on the outer ring and a reflector surface b aligned at the angle W2 in relation to the light irradiation direction L and arranged opposite on the inner ring. The light beams are therefore reflected downward at a 45° angle by the reflector surfaces a in the outer ring and the light beams are reflected back upward by 135° by the reflector surfaces b on the inner ring. Illumination options: flattop/top hat beam profile, annular beam profile. Advantageous illumination options of the light reflector element 1 are a “flattop” or “top hat” beam profile aligned centered on the center axis Z or an annular beam profile.

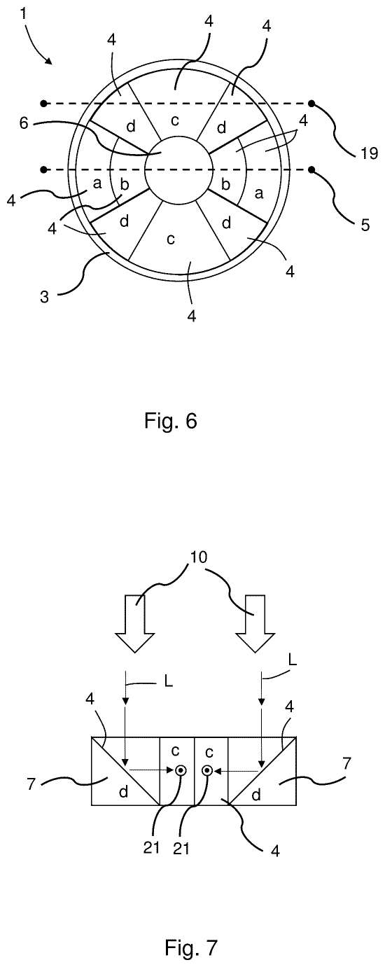

A further embodiment of a light reflector element 1 will be described on the basis of FIGS. 6 to 8. The light reflector element 1 is shown in a top view in FIG. 6. The central plane of section 5 is also again shown in FIG. 6. In the central plane of section 5, the light reflector element 1 from FIG. 6 has a structure comparable to the light reflector element 1 from FIG. 4, i.e. the same illustration results in the plane of section 5 with the light reflector element 1 from FIG. 6 as in FIG. 5. Accordingly, reflector surfaces a, b associated with one another of a pair a, b are also present, which are arranged at different radial distances from the center. However, only two pairs a, b of the reflector surfaces 4 are present.

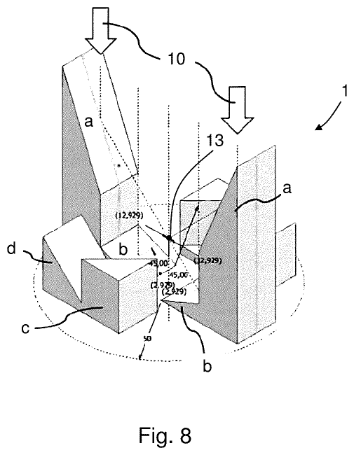

FIG. 7 shows the light reflector element 1 in a sectional view in the decentral plane of section 19 shown in FIG. 6. As can be seen, the light reflector element 1 has a further pair c of the reflector surfaces 4 associated with one another. These reflector surfaces 4 of the further pair c are aligned at an angle of 45° with respect to a straight line which extends orthogonally to the predefined light irradiation direction L of the light reflector element 1 and intersects the center axis Z. Moreover, at least one auxiliary reflector surface d, which deflects light irradiated in the light irradiation direction L onto the reflector surface c, is associated with each of the reflector surfaces c of the further pair. A further spatial direction of the light for a three-dimensional magnetooptical trap can be generated by this arrangement of reflector surfaces c, d even with an annularly irradiated light beam profile. In this embodiment, the coils of the magnetooptical trap can be installed not on the axis of the entire element, but rather above or below this entire element. Advantageous illumination options of the light reflector element 1 are a “flattop” or “top hat” beam profile aligned centered on the center axis Z or an annular beam profile. FIG. 8 shows the light reflector element 1 according to FIGS. 6 and 7 in a perspective view, by which illumination options and the light deflections are illustrated even better.

The reflector surfaces a and b in FIGS. 2 and 3, which cause a reflection at a steep or flat angle, respectively, can alternatively also be replaced by two elements pivoted in relation to one another, which each deflect individually by 90°, if this is preferred due to polarization properties.

An equivalent observation applies to the light reflector element 1 in FIGS. 4 and 8, wherein the reflector surfaces a and b can alternatively also be replaced by two elements pivoted in relation to one another, which each deflect individually by 90°. An arrangement of reflector surfaces c, d can be replaced by a single reflector surface c, which deflects the light from the predefined light irradiation direction L directly by 90° into the center.

The light reflector element 1 can be monolithically manufactured, for example by milling, pressing, or 3D printing, depending on the material, or alternatively also can be joined from individual partial components. The reflection at the reflector surfaces can be optimized, for example, by polishing or coating depending on the requirement and the material of the overall element. Monolithic manufacturing offers the advantage of a significantly reduced alignment effort in the component manufacturing, and possibly passive stability.

All variants of the light reflector element 1 are suitable for a 3D magnetooptical trap. The angles W1, W2 can be selected differently, the antiparallelism of the wave vectors of the reflected light fields is essential.

In all variants of the light reflector element 1, the base body 3, for example in the form of a frame element, can be provided with holes or recesses in order to enable a further access, for example for the atom beam from a 2D-magnetooptical trap for faster charging of the 3D-magnetooptical trap or an optical access.

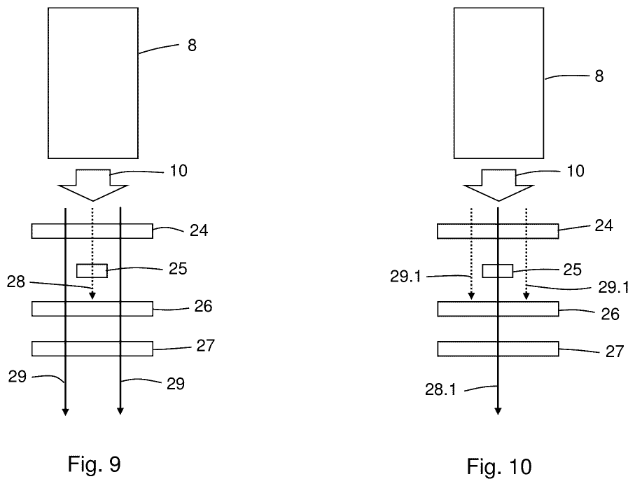

It will be schematically explained on the basis of FIGS. 9 and 10 how the light 10 of the light source 8 can be introduced into the light reflector element 1 or into the vacuum chamber 17. The arrangement shown in FIGS. 9 and 10 can accordingly be connected upstream from the light reflector element 1 or the vacuum chamber 17. FIG. 9 shows the introduction of the light 10 during the laser cooling of the atoms in the interaction zone 13, FIG. 10 shows the introduction of the light 10 after the decoupling of the atoms from the atom trap and during the performance of the interferometry process.

The arrangement shown in FIGS. 9 and 10 includes an adjustable retarder plate 24, for example an LCVR. A second retarder plate 25 is arranged after the adjustable retarder plate 24 in the light irradiation direction L. A polarization filter 26, for example a film or a polarization beam splitter cube, is arranged behind the second retarder plate 25. A third retarder plate 27 can optionally also be arranged behind the polarization filter 26.

In the cooling configuration from FIG. 9, the central light component 28 of the light 10 is blocked and therefore does not reach the light reflector element 1. In contrast, the outer light components 29 are transmitted by the described arrangement and reach the light reflector element 1.

In the interferometry configuration from FIG. 10, the central light component 28.1 is transmitted by the described arrangement and can therefore radiate through the light reflector element 1. In contrast, the outer light components 29.1 are blocked in this configuration and do not reach the light reflector element 1.

The combination of the elements 24, 25, and 26 enables switching between illumination of the decentral reflector surfaces 4 of the light reflector element 1 or optionally the light-transmitting central area 6. The targeted illumination of the center of the light reflector element 1 or the vacuum chamber 17 enables, for example, in conjunction with further elements, for example, a retroreflection mirror 14, the implementation of a beam configuration which is suitable for an atomic interferometer.

The second retarder plate 25 can be designed as a variant so that an annular area around the center is deliberately permanently blocked. The order of the retarder plates 24, 25 is interchangeable. The functionality of the elements 24, 25, 26 can also be implemented differently. The functionality having the switching capability between the illumination of the outer ring or alternatively the center is essential here.

1. A light reflector element, comprising:
multiple reflector surfaces aligned at different predefined angles with respect to a predefined light irradiation direction of the light reflector element, wherein the multiple reflector surfaces are arranged around a center of the light reflector element,
wherein the multiple reflector surfaces include one or more pairs of reflector surfaces associated with one another, wherein the reflector surfaces of the one or more pairs of reflector surfaces are arranged diametrically opposite to one another with respect to the center of the light reflector element so that light irradiated in the predefined light irradiation direction is deflected by the one or more pairs of reflector surfaces into a plurality of light beams which extend toward one another in different spatial directions and meet in a center axis which extends through the center in the predefined light irradiation direction,
wherein a first reflector surface of a first pair of the one or more pairs of reflector surfaces is aligned at an angle in a range of 46° to 89° with respect to the predefined light irradiation direction of the light reflector element, and
wherein a second reflector surface of the first pair of the one or more pairs of reflector surfaces is aligned at an angle in the range of 1° to 44° with respect to the predefined light irradiation direction of the light reflector element.

2. The light reflector element as claimed in claim 1, wherein the first reflector surface of the first pair of the one or more pairs of reflector surfaces is aligned at an angle which is essentially equal to 67.5° with respect to the predefined light irradiation direction of the light reflector element, and wherein the second reflector surface of the first pair of the one or more pairs of reflector surfaces is aligned at an angle which is essentially equal to 22.5° with respect to the predefined light irradiation direction of the light reflector element.

3. The light reflector element as claimed in claim 1, wherein the first reflector surface of the first pair of the one or more pairs of reflector surfaces is aligned at an angle W1 with respect to the predefined light irradiation direction of the light reflector element, and wherein the second reflector surface of the first pair of the one or more pairs of reflector surfaces is aligned at an angle W2 with respect to the predefined light irradiation direction of the light reflector element, wherein a sum of W1 and W2 is essentially equal to 90°.

4. The light reflector element as claimed in claim 1 wherein the one or more pairs of reflector surfaces associated with one another of the multiple reflector surfaces is either three pairs or a multiple of three pairs.

5. The light reflector element as claimed in claim 1 wherein the multiple reflector surfaces comprise at least one pair of reflector surfaces associated with one another in which both reflector surfaces of the at least one pair are aligned at an angle of 45° with respect to a straight line which extends orthogonally to the predefined light irradiation direction of the light reflector element and intersects the center axis.

6. The light reflector element as claimed in claim 5, wherein the at least one pair of reflector surfaces associated with one another in which both reflector surfaces of the at least one pair are aligned at an angle of 45° with respect to a straight line which extends orthogonally to the predefined light irradiation direction of the light reflector element include at least one auxiliary reflector surface which deflects light irradiated in the predefined light irradiation direction of the light reflector element onto an associated reflector surface of the at least one pair of reflector surfaces.

7. The light reflector element as claimed in claim 1 further comprising one or more light-transmitting sections arranged between reflector surfaces that are adjacent in the circumferential direction of the multiple reflector surfaces, wherein light incident in the predefined light irradiation direction radiates through the light reflector element.

8. The light reflector element as claimed in claim 7, wherein one, multiple, or all of the one or more light-transmitting sections are formed as a free space in which no material is arranged.

9. The light reflector element as claimed in claim 1 wherein at least a plurality of the multiple reflector surfaces are arranged at a distance from the center of the light reflector element so that a central light-transmitting section is formed around the center of the light reflector element, through which light incident in the predefined light irradiation direction can radiate through the light reflector element.

10. The light reflector element as claimed in claim 1 wherein the light reflector element is designed as a monolithic component.

11. The light reflector element as claimed in claim 1 wherein one, multiple, or all of the multiple reflector surfaces are each designed as a level surface.

12. An atomic device, comprising:
at least one laser light source;
an atom trap comprising
at least one first interaction zone for cooling trapped atoms by way of laser light of the at least one laser light source irradiated from opposite directions onto trapped atoms; and
a first light reflector element as claimed in claim 1, wherein a light emission direction of the at least one laser light source is aligned in the predefined light irradiation direction of the first light reflector element, wherein the at least one first interaction zone is at least partially formed by the first light reflector element.

13. The atomic device as claimed in claim 12, wherein the atom trap is designed as a three-dimensionally acting atom trap, wherein vectorial components of laser light irradiated from opposite directions onto the trapped atoms comprise all spatial axes in the first interaction zone.

14. The atomic device as claimed in claim 12, wherein the atomic device is designed on a side of the first light reflector element facing away from the at least one laser light source without a light beam path extending along the center axis.

15. The atomic device as claimed in claim 14, wherein the atomic device is designed without a mirror arranged behind the first light reflector element in the predefined light irradiation direction, by which light irradiated in the predefined light irradiation direction is reflected back opposite to the predefined light irradiation direction.

16. The atomic device as claimed in claim 12 wherein the at least one interaction zone includes at least two interaction zones spaced apart from one another for cooling trapped atoms by way of laser light irradiated from opposite directions on the trapped atoms, wherein the atomic device further comprises a second light reflector element arranged behind the first light reflector element in the predefined light irradiation direction, wherein a second interaction zone of the at least two interaction zones is at least partially formed by the second light reflector element.
